(19) United States
(12) Patent Application Publication
(10) Pub. No.: US 2009/0277566 A1
(43) Pub. Date: Nov. 12, 2009

(54) Securing a Fabric Mold Liner

(75) Inventors: Stephen J. Lawrence, St. Catharines (CA); Michael Cina, Etobicoke (CA); Daniel Lee Janzen, Brampton (CA); Stephane Girard, Toronto (CA)

Correspondence Address: FISH & RICHARDSON P.C., P.O BOX 1022, Minneapolis, MN, 55440-1022, US

(73) Assignee: Velcro Industries B.V., Curacao (NL)

(21) Appl. No.: 12/436,921

(22) Filed: May 7, 2009

Related U.S. Application Data
(60) Provisional application No. 61/051,245, filed on May 7, 2008.

(51) Int. Cl. B32B 37/15; B05D 7/24; B32B 5/02

(52) U.S. Cl. 156/78; 427/130; 442/59

(57) ABSTRACT

A fabric mold liner includes a flexible fabric substrate and bounded regions of cured binder encapsulating fibers of the fabric substrate and carrying magnetically attractable particles. A liquid containing ferrous particles in suspension in a binder is deposited on the substrate in discrete, selected regions arranged to correspond to magnetic liner retention points in a mold cavity. The mold liner is used in molding a foam article. The liner is inserted into a mold cavity with the liner positioned such that the bounded regions carrying the binder align with magnetic liner retention points of internal surface. A foamable resin is introduced into the mold and is caused to expand to fill the mold cavity and cover an exposed surface of the liner, such that the liner becomes bonded to, and becomes a part of, a foam body formed by the resin.

### CROSS-REFERENCE TO RELATED APPLICATIONS

This application claims priority to U.S. Provisional Application Ser. No. 61/051,245, filed on May 7, 2008.

### TECHNICAL FIELD

This invention relates to fabric mold liners for use as inserts in molding processes.

### BACKGROUND

In the molding of foam articles such as automotive seat buns, fabric liners are commonly placed into the mold cavity prior to introducing the foaming resin that forms the bun. The liner is bonded to the foam in the process and forms a surface of the finished seat bun. In many cases the liners are held in position within the mold cavity during seat bun molding by manually positioning and adhering magnetically attractable stickers (known in the automotive seat foam bun industry as magnetic dots or “MCAs”) to the liner and embedding corresponding magnets within the seat bun mold cavity. MCAs are generally small circles or hexagons stamped from a sheet of rubberized material that includes iron filings and an adhesive backing.

Improvements are sought in the retention of liners within mold cavities.

### SUMMARY

One aspect of the invention features a method of molding a foam article. The method includes providing a flexible fabric mold liner composed of a fabric substrate with discrete, bounded regions carrying cured binder encapsulating fibers of the fabric substrate and containing magnetically attractable particles. The mold liner is inserted into a mold cavity such that the liner drapes over an internal surface defining a portion of the mold cavity, with the liner positioned such that the bounded regions carrying the cured binder align with magnetic liner retention points on an internal surface of the mold cavity, whereby the liner is retained in position within the mold cavity. Foamable resin is introduced into the mold; and causing the foamable resin to expand to fill the mold cavity and cover an exposed surface of the liner, such that the liner becomes bonded to, and becomes a part of, a foam body formed by the resin.

In some cases, the liner is embedded within a foam product formed in the mold cavity.

Some applications include magnetically detecting the location of the magnetically attractable particles to align the bounded regions with the magnets in the mold cavity.

In some cases, the fabric liner provides a surface that has greater structural rigidity than that of the cured foam.

Another aspect of the invention features a method of making a fabric mold liner includes providing a flexible fabric liner substrate and depositing in discrete, bounded regions on the fabric a binder containing magnetically attractable particles. The bounded regions are arranged to correspond to magnetic liner retention points in a corresponding mold cavity. The deposited binder is cured on the fabric to bind the magnetically attractable particles to the substrate.

In some applications, the binder encapsulates individual fibers of the fabric liner substrate. Because the cured binder and particles are integral to the flexible fabric liner, bending, folding or wearing of the flexible fabric liner will not separate the magnetically attractable particles from the substrate. It is also advantageous that the bounded regions can be essentially as flexible as the substrate so as not to limit the location or number of bounded regions only to flat surfaces of the mold cavity. It is further advantageous that the bounded region including magnetically attractable particles need not protrude above the substrate.

In some applications, cutting the fabric liner substrate forms a liner insert having a periphery shaped to correspond to a desired surface covering of a finished molded product.

In some cases, the fabric liner substrate is porous and the binder penetrates the fabric liner substrate to at least about 20 percent of the thickness of the fabric liner substrate.

In some applications, the binder is applied from a first side of the substrate and penetrates through the substrate to form an exposed surface on an opposite side of the substrate.

In some applications, the liquid is deposited by one of contactless printing, contact printing, blotting, brushing, screen printing, spraying, misting, injecting and static deposition.

In some applications, depositing includes drawing a vacuum at the discrete, bounded regions to draw the binder into the substrate.

In some applications, depositing includes positioning a magnet to draw the binder into the substrate.

In some applications, the curing includes evaporation, ultraviolet irradiation, heating or forced convection.

Some applications include detecting using magnetic sensing one of the discrete, bounded regions of the deposited binder to reference a predetermined cut to be made in the substrate.

Some applications include coordinating the discrete, bounded regions for the depositing and a location for cutting the substrate by detection of a through-hole formed in the substrate.

In some cases, the substrate is a nonwoven fabric.

In some cases, the nonwoven comprises polyester fibers.

In some cases, the substrate is a spunbonded needle punched polypropylene (SNP).

In some applications, the binder comprises, a water-based latex emulsion, water-based urethane binder coating, acrylic based emulsion, oil-based emulsion, a latex paint, acrylic paint, oil-based paint, low-tack adhesive, hot melt adhesive, molten plastic resin, epoxy adhesive or vinyl resin.

In some applications, depositing includes depositing the binder on two opposing faces of the substrate.

Some applications include depositing the binder to form discrete, bounded regions leaving other areas of the substrate free of the magnetically attractable particles.

In some cases, the magnetically attractable particles are substantially evenly dispersed throughout the deposited binder.

In some cases, the deposited binder is visually distinct from the substrate.

Another aspect of the invention features a fabric mold liner including a flexible fabric substrate and bounded regions of cured binder encapsulating fibers of the fabric substrate and carrying magnetically attractable particles. The bounded regions are arranged to correspond to magnetic liner retention points in a corresponding mold cavity.

In some cases, the stiffness of the bounded regions is not substantially greater than the stiffness of the bare fabric substrate.

In some cases, the cured binder includes between about 50 and 90 percent concentration by mass of the magnetically attractable particles.

In some cases, the cured binder includes between about 70 and 85 percent concentration by mass of the magnetically attractable particles.

In some implementations, the cured binder is present on two opposing faces of the liner.

In some cases, the liner has a periphery shaped to correspond to a desired surface covering of a finished molded product.

In some implementations, the fabric liner substrate is porous and the cured binder is present in the fabric liner substrate to a depth of at least about 20 percent of the thickness of the fabric liner substrate.

In some cases, the fabric liner substrate is a nonwoven fabric.

In some cases, the nonwoven comprises polyester fibers.

In some cases, the fabric liner substrate is a spunbonded needle punched polypropylene (SNP).

In some cases, the spunbonded needle-punched polypropylene (SNP) has a typical material density of between 2.5-4.0 oz/yd (77.5-124 g/m).

In some cases, the fabric liner substrate is polyester felt material.

In some implementations, the polyester felt material has a typical material density of between 10.0-15.0 oz/yd (310←465 g/m).

In some implementations, the cured binder includes a water-based latex emulsion, water-based urethane binder coating, acrylic-based emulsion, oil-based emulsion, a latex paint, acrylic paint, oil-based paint, low-tack adhesive, hot melt adhesive, molten plastic resin, epoxy adhesive or vinyl resin.

Another aspect of the invention features a method of cleaning the magnetically attractable material from an orifice associated with the spray nozzle. The method includes inserting a magnetic plunger into the orifice to clear any build-up of magnetically attractable material. The plunger can be passed through a stencil opening, a spray nozzle, or other orifice subject to deposition build-up. Regular cleaning of the spray nozzle helps maintain an even spray pattern and consistent deposition. The plunger can be activated using an air cylinder and can be cleaned between plunge cycles.

In a particular implementation, the plunger is a metallic hollow shaft of about 0.500 (1.27 cm) inch in diameter with a wall thickness of about 1/16 inch (1.6 mm) and contains cylindrical rare-earth magnets. The magnets are installed with opposing like poles to magnify the magnetic field. The plunger is plunged into the stencil nozzle opening of about 0.75 inch (1.9 cm) diameter and attracts the residual iron-filled liquid from the inner diameter of the stencil nozzle to prepare for the next deposition machine cycle. Multiple successive plunges can be used to clean a discreet number of positions equally spaced along a circle close to the circumference of the cleaning nozzle, or a continuous circular path can be followed with one singular plunge, such that the stencil nozzle is entirely cleaned and prepared for the next deposition.

Another aspect of the invention features a method of detecting the quantity of magnetically attractable material in a bounded region. The method includes passing a sensor adjacent the bounded region to obtain a reading that can be correlated with a volume of metal present in the bounded region. One suitable sensor is the KEYENCE Brand EX-416V high speed magnetic field sensor, that includes a high accuracy digital displacement inductive sensor. The sensor is positioned about 2 mm above the deposition to detect the amount of iron in the deposition. The sensor is connected to an electronic amplifier which provides a digital readout indicating a value that is correlated to an iron content amount.

Another aspect of the invention features a method of enhancing detection of the location of the bounded regions of deposited materials. The method includes adding a luminescent component to the deposited material, for example, for easy visual detection under ultraviolet lighting. Any number of phosphorescent or similarly luminescent materials may be added to improve visual detection under desired lighting conditions.

For example, in some cases it is desirable to use automatic means to detect if the deposition has been made in the correct locations. Using a luminescent powder additive in the liquid mixture (such additives are available from YaDa Special Luminous Material Co., Ltd., located in Wuxi, Jiangsu province, China), the liquid deposition can be more easily inspected by camera assisted means since the luminescent powder additive creates a greater contrast between the metal filled liquid and the substrate when subjected to ultraviolet light.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a perspective view of a mold cavity having magnetic retention points.

FIG. 2 is a top view of one implementation of a fabric mold liner for use with the mold cavity of FIG. 1.

FIG. 3 is a partial cross-sectional view of one implementation of the fabric liner of FIG. 2.

FIG. 4 is a partial cross-sectional view of another implementation of the fabric liner of FIG. 2.

FIG. 5 illustrates a deposition system and method for manufacturing a fabric liner.

FIG. 6 is an enlarged view of the deposition of magnetically attractable material, as shown in FIG. 5.

FIG. 7 is an enlarged view of another implementation of the deposition of magnetically attractable material.

FIG. 8 is an enlarged view of another implementation of the deposition of magnetically attractable material.

FIG. 9 is a top view of a bi-axial deposition station.

FIG. 10 illustrates a schematic inline workstation process flow according to one application.

Like reference symbols in the various drawings indicate like elements.

### DETAILED DESCRIPTION

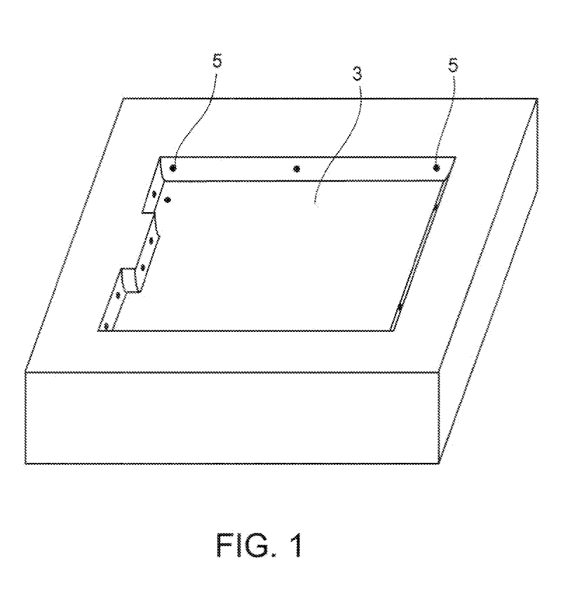

With reference to FIG. 1, a mold cavity 3 includes magnetic retention features 5 along sidewalls of an interior surface. Mold cavity 3 can be contoured to form a foam seat bun. Magnetic retention points 5 are generally magnets recessed within the sidewalls of mold cavity 3.

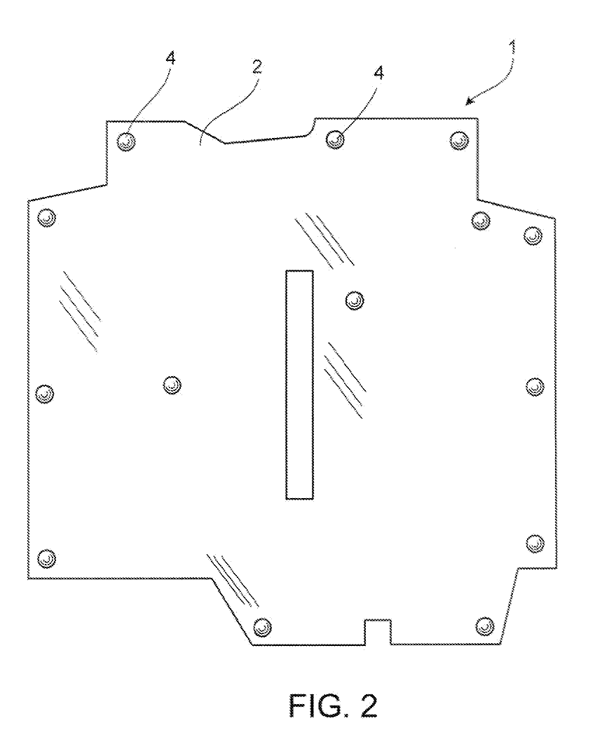

FIG. 2 shows a fabric mold liner 1 for use in mold cavity 3. Fabric mold liner 1 includes a flexible fabric liner substrate 2 with magnetically attractable bounded regions 4. Fabric liner 1 is draped over mold cavity 3 and retained within cavity 3 by magnetic attraction between magnetically attractable bounded regions 4 and corresponding magnetic retention points 5 in mold cavity 3. The periphery of fabric liner substrate 2 is formed to correspond to the outer contours of mold cavity 3 with fabric liner 1 positioned along a central region of mold cavity 3.

Fabric mold liner 1 serves to contain and reinforce a foam bun formed in mold cavity 3. For example, in one implementation, fabric mold liner 1 becomes the bottom surface of a seat foam bun when it is installed in a vehicle. Fabric mold liner 1 can be used to adhere the foam bun to a support structure and can help reinforce the foam bun.

Fabric liner substrate 2 can be a flexible material capable of conforming to the contours of mold cavity 3.

Fabric liner substrate 2 can be relatively impermeable to the foam used in forming the foam bun such that fabric liner 1 is effectively bonded to the seat foam bun during the foaming process. Alternatively, fabric liner substrate 2 can be more porous to receive the foam during the foaming process such that fabric liner 1 becomes partially embedded in the foam bun.

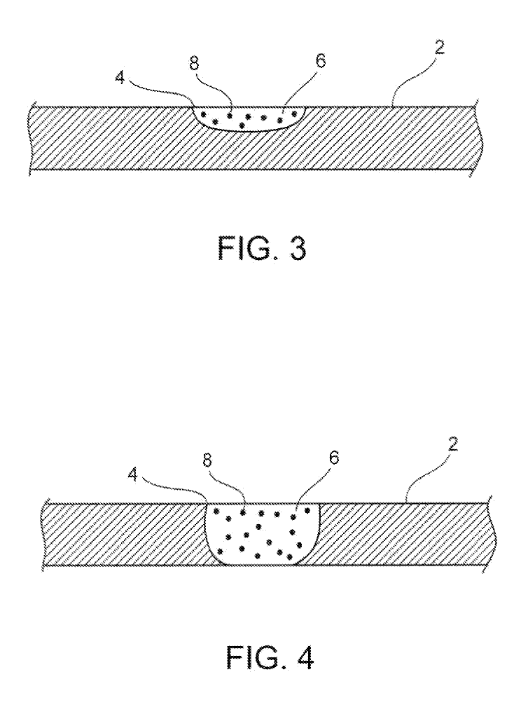

With continued reference to FIG. 2, one implementation of fabric mold liner 1 includes a fabric liner substrate 2 with bounded regions 4 formed of a cured binder (FIGS. 3-4) having a concentration of magnetically attractable particles (FIGS. 3-4). Bounded regions 4 can be an array of distributed dots or can form connected regions to correspond to any number of contours or features of mold cavity 3.

For example, magnetic retention points 5 can be positioned at the ends, corners and edges of various mold cavity contours or sidewalls. Fabric liner 2 is then installed within mold cavity 3 by aligning and contacting bounded regions 4 with magnetic retention points 5. Magnetic retention points 5 can be spaced apart along broad planar regions of mold cavity 3, for example adjacent the plateau of the seat foam bun. Magnetic retention points 5 can be placed closer together in the corners of mold cavity 3 such that fabric liner 2 is bunched or folded and secured in the corners of mold cavity 3. Alternatively, bounded regions 4 can define elongated or extended regions corresponding to elongated or extended magnetic retention points, for example, along an elongated recess or along a mold sidewall.

With reference to FIG. 3, bounded regions 4 on substrate 2 include a cured binder 6 and magnetically attractable particles 8. Cured binder 6 can be deposited on substrate 2 by contact printing including, for example, blotting, stamping, silk screening and brushing, or by contactless printing, for example, by inkjet printing, sputter or spray deposition, or by any other known deposition method. Cured binder 6 encapsulates fibers of fabric substrate 2 to render particles 8 of bounded regions 4 integral to fabric liner 1. Thus, bounded regions 4 are not readily separable from substrate 2 as previously experienced with known MCAs that are merely adhered to the surface of a fabric liner.

In some embodiments, bounded regions 4 are not substantially stiffer than substrate 2. Bounded regions 4 encapsulate fibers of substrate 2 or extend into pores of substrate 2 so as to not be readily separable from substrate 2 upon normal bending or folding of fabric liner 1 in the area of bounded regions 4 during shipping, handling or installation of liner 1. In other implementations, bounded regions 4 are arranged to provide a stiffer grip for fabric liner 1 during installation.

Fabric liner substrate 2 is preferably a woven or nonwoven fabric suitable for use as a mold liner. Examples of suitable substrate materials include, fibrous polyester materials and spunbonded needle punched polypropylene (SNP). Suitable polyester nonwoven materials of about 2-4 ounces per yard (62-124 g/m) and SNP materials of about 4 oz/yd (124 g/m) per square yard are available from Hanes Engineered Materials of Berkley Mich. Another suitable substrate is a CelFil material, 10-16 oz/yd (310-496 g/m), available from POLIMEROS Y DERIVADOS, S.A. DE C.V., Leon, Mexico.

Cured binder 6 is a material suitable to suspend particles 8 during deposition on substrate 2 and to fix particles 8 in place on substrate 2 upon curing of binder 6. Examples of suitable binders 6 include acrylic, water-based latex or oil-based emulsions, water-based urethane binder coating, a latex paint, acrylic paint, oil-based paint, hot melt adhesives, low tack adhesives, molten plastic resins, epoxy adhesives and vinyl resins. Binder 6 preferably encapsulates fibers at the surface of substrate 2 and penetrates into pores in substrate 2. Binder 6 can be injected into substrate 2 so as to displace or encapsulate fibers in the injection area. For example, binder 6 can be injected into a film substrate 2. Use of vacuum or magnetic forces during deposition can be used to enhance penetration of binder 6 into substrate 2. The binder can be formulated to ‘wet’ the surfaces of fibers or other substrate features for enhanced bonding upon curing. During curing the binder can lose mass and volume, and in some cases can become further dispersed and drawn into interstices between fibers, further enhancing flexibility in the bounded regions while retaining the magnetically attractable particles.

Magnetically attractable particles 8 are preferably dispersed throughout cured binder 6. One suitable magnetically attractable material for use as particles 8 is ATOMET 29 iron powder (95.0% by wt. screen size 106 μm), which is available from Quebec Metal Products Ltd. of Sorel-Tracy, Quebec, Canada. Another suitable metal powder material is ATOMET 195SP, (97.7% by wt. screen size 45 μm), which is available from the same manufacturer.

Particles 8 can be sized to pass through pores of substrate 2 to enhance penetration of binder 6 into substrate 2, such that the magnetically attractable particles become embedded within the substrate and the binder becomes integrally infused into the substrate. Particles 8 can include any number of metals, alloys or coatings and can be annealed or otherwise treated to affect particle properties.

Binder 6 is depicted in FIG. 3 as extending beyond the surface and into the thickness of substrate 2. In some implementations, it is advantageous for cured binder 6 to extend into at least 20% of the thickness of substrate 2. Binder 6 can encapsulate substrate fibers primarily at the surface of substrate 2 in other embodiments. Depending on the thickness of substrate 2, penetration of binder 6 into substrate 2 and the concentration of particles 8 in binder 6, liner 1 can be retained by magnetic retention points from either face of liner 1.

For example, in another implementation shown in FIG.4, cured binder 6 extends substantially the entire thickness of substrate 2. Presence of cured binder 6 and particles 8 near both opposing faces of fabric liner 1 provides increased flexibility of design of both fabric liner 1 and mold cavity 3. For example, fabric mold liner 1 can be installed with either side up if particles 8 are of sufficient concentration adjacent both faces of liner 1 and magnetic retention point 5 can be located on opposing surfaces of mold cavity 3.

In some implementations, it is advantageous for the concentration of particles 8 in cured binder 6 to be between about 50 and 90 percent by mass. In some implementations, a particle concentration of between about 60 and 80 percent, and more preferably about 70 percent provides good magnetic retention characteristics. The effective quantity of particles 8 at any of bounded regions 4 can be varied, for example, by adjusting the concentration of particles 8 in binder 8 by applying varying thickness or numbers of coatings of binder 8 to form bounded regions 4.

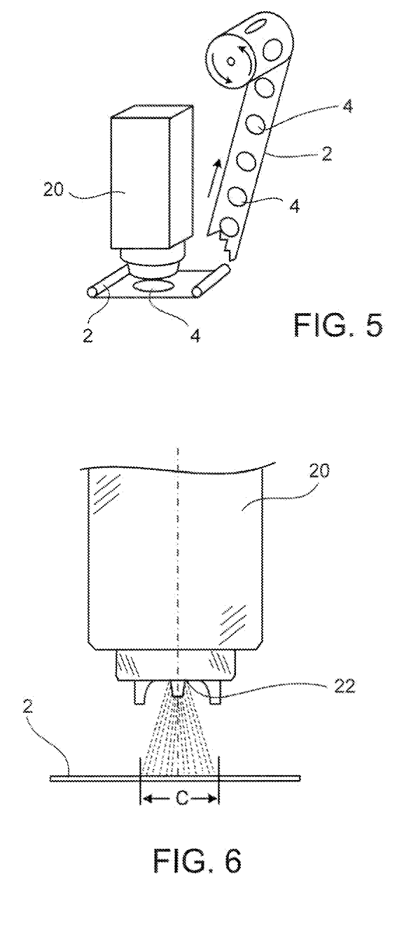

One example method of making fabric liner 1 is described with reference to FIG. 5. Substrate 2 is positioned below a print head 20 constructed and arranged to deposit a binder bearing magnetically attractable particles 8. Print head 20 can be advantageously constructed of an abrasive resistant material such as hardened alloy steel. Air pressure or piezoelectric forces can be used to expel the binder from print head 20.

In a particular application, the magnetically attractable material is prepared by shake mixing 0.6 kg of paint with 1.4 kg of iron powder for 10 minutes. Short bursts of between about 0.02 to 0.06 seconds from a Binks 95A spray nozzle at 5-30 psi (34.4-206.8 kPa) fluid pressure regulated by a fluid regulator (Devilbiss model # HGS 5112) and 10-300 psi (68.9-206.8 kPa) atomization pressure and at a distance of about 0.25-2 inch (6-50 mm) deposits sufficient quantity of binder 6 and metallic particles 8 on substrate 2. The spray nozzle orifice thickness is provided about its circumference with about a 20 degree outward relief flare to provide a non-flat surface to reduce build-up of the binder from repeated deposition cycles, and to redirect particle and liquid bounce back into the bounded region during deposition. Similarly, the spray nozzle interior defines an outwardly directed deflector surface adjacent the orifice to initially deflect non-deposited binder, i.e., binder beyond the orifice profile, away from the orifice to reduce build-up of binder around the orifice. It was determined that a downward deflector angle of about 15 degrees plus or minus 5 degrees relative to the plane of the orifice is sufficient to deflect that portion of the downward flow of binder outside the orifice profile. A fluid viscosity of about 22,000-33,000 CPS (measured using a Brookfield Viscometer Model #LVF and Spindle#4) is suitable to provide consistent dispersion coverage, maintain the iron powder in suspension and prevent excess dripping or clogging. The deposited binder can be initially set with forced air fans and cured in an oven.

With reference to FIG. 6, print head 20 can include a spray nozzle 22 for delivering a fixed amount of binder to substrate 2 over a predetermined area “C”. The dimensions of area C can be varied by varying the spray pattern of print head 20 or by relative movement of substrate 2 and print head 20.

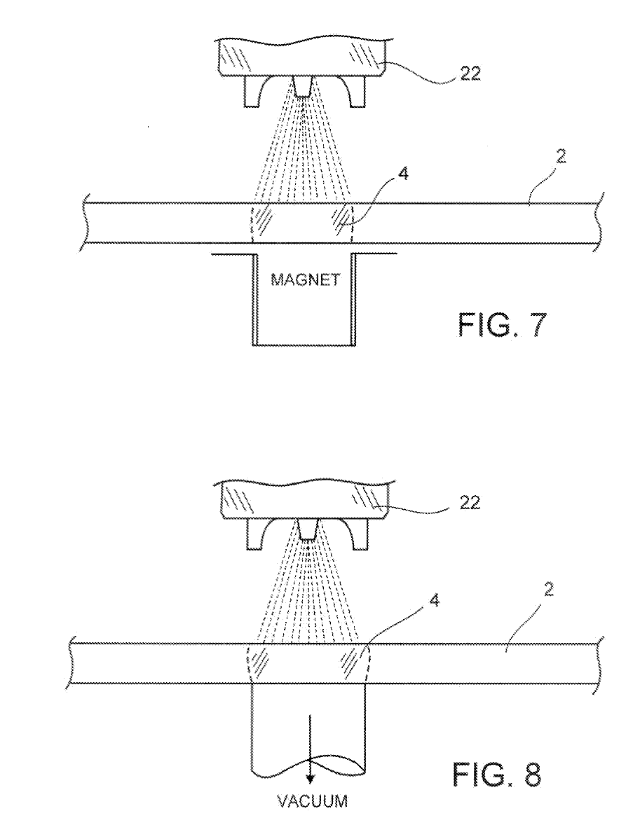

In another implementation shown in FIG. 7, a magnetic field is provided adjacent the location of bounded region 4 during deposition of binder 6 to help draw particles 8 and binder 6 into or against substrate 2.

In another implementation shown in FIG. 8, a vacuum is applied to substrate 2 at the location of bounded region 4 to help draw particles 8 and binder 6 into substrate 2.

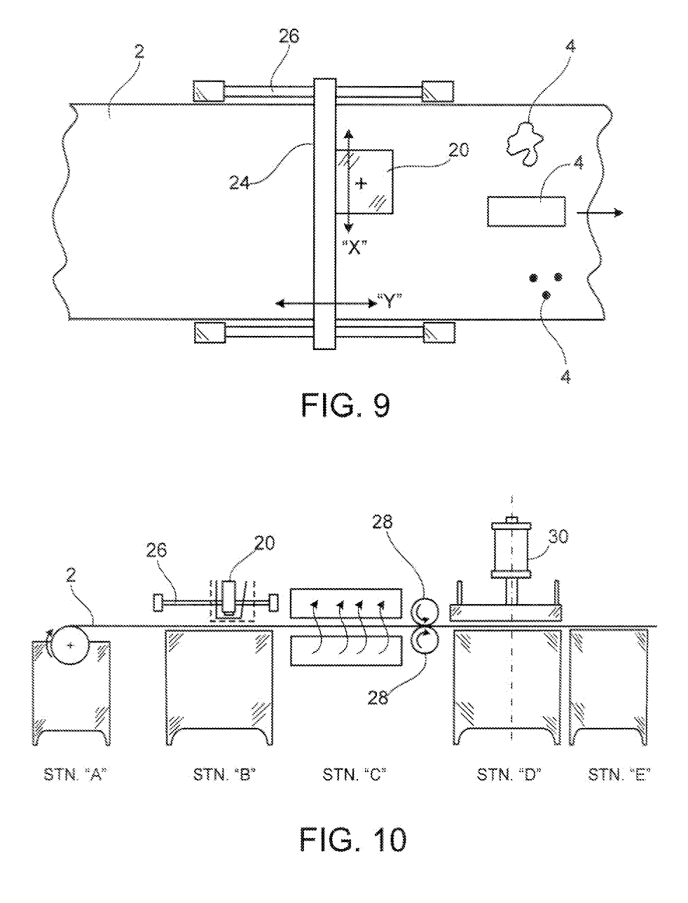

For example, in FIG. 9, print head 20 is depicted in an X-Y bi-axial coordinate system including an X-axis assembly 24 and Y-axis assembly 26 by which print head 20 is positionable at fixed X-Y coordinates relative to substrate 2. Assemblies 24 and 26 are moveable according to preprogrammed instructions defining the dimensions and patterns for bounded regions 4 for a particular fabric mold liner 1. Assemblies 24 and 26 can be actuated by ball screws, servos, or any number of linear actuator systems.

With reference to FIG. 10, an example process flow is illustrated in which substrate 2 is a non-woven synthetic fabric provided in roll form as shown at STN “A”. Substrate 2 is pulled by pressure nip rollers 28 through the various stations A-E. At STN “B”, substrate 2 passes beneath print head 20 while the positional X-Y assemblies 24, 26 to which 20 is affixed, are moved to preprogrammed locations via a signal from a programmable logic controller. Once print head 20 is located at the desired X-Y coordinate, print head 20 deposits a measured amount of a binder with metallic particles 8. Masks or stencils can also be employed with print head 20 to obtain a desired shape for a bounded region to reduce the effects of overspray or edge bleeding.

Substrate 2 is advanced to STN “C” where warmed air, at a rate of between 5-15 meters/second is recirculated and partially vented through and around substrate 2 to facilitate rapid curing of the binder material on the substrate. Substrate material enters STN “D” where it is cut using a horizontal bed die cutting press 30. Cutting press 30 lowers upon substrate 2 causing a peripheral pattern to be cut into substrate 2 indexed to bounded regions 4. Cutting at STN “D” can be indexed to bounded regions 4 using magnetic detection of bounded regions 4, an indexing through-hole or other suitable indexing structure or feature. Additional post cutting, finishing, stacking, packaging and waste material disposal can be conducted at STN “E.”

In another implementation, a stencil strip is provided over substrate 2 during deposition of the binder. The stencil strip is preferably resistant to deterioration by the binder and includes holes corresponding to the shape of the desired bounded regions 4. The stencil strip can be suspended a fixed distance from substrate 2 and can be moveable, or changeable to vary a deposit shape or to provide a fresh stencil opening.

In preparation for molding of foamed article, flexible fabric mold liner 1 including fabric substrate 2 and discrete, bounded regions 4 is inserted into mold cavity 3 such that liner 1 drapes over an internal surface defining a portion of mold cavity 3. Bounded regions 4 are composed of cured binder 6 and magnetically attractable particles 8 and are aligned with magnetic liner retention points 5 on internal surfaces of mold cavity 3, whereby liner 1 is retained in position within mold cavity 3.

A foamable resin is then introduced into mold cavity 3 and activated to expand to fill mold cavity 3 and cover an exposed surface of liner 1. Liner 1 becomes bonded to, and becomes a part of, a foam body formed by the foamed resin.

In some embodiments, rapid curing includes ultraviolet irradiation, forced convection or use of catalysts. In some embodiments, cured binder 8 is melted onto or into substrate 2. In other implementations binder 8 is injected into the thickness of substrate 2 and can displace fibers of substrate 2.

In some implementations, bounded regions 4 are about 19 mm in diameter. In some implementations, bounded regions 4 are positioned at between about 4 and 20 locations on substrate 2.

In some applications, a magnet is positioned below substrate 2 during application of the binder to improve penetration of particles 8 into substrate 2 or to reduce overspray.

In some implementations, fabric liner 1 includes apertures to receive projections present in mold cavity 3. The apertures can be formed before, during or after formation of bounded areas 4 and can serve as a reference for location of bounded areas 4 and location of substrate 2 during cutting of the linear periphery.

In some implementations, the liquid binder contains about 50% particles 8 by mass and cured binder 6 contains about 75-80 percent by mass of particles 8.

In some applications, cured binder 6 results from application of a thin binder for deeper penetration into substrate 2. In other applications, cured binder 6 results from application of a thicker binder to provide an increased mass of particles 8 in bounded region 4.

In some implementations, detection of particles 8 is used by automation equipment to detect a position of fabric mold liner 1 and to orient fabric mold liner 1 in mold cavity 3.

In some applications, bounded regions 4 define distributed points, elongated patches and contoured patches of cured binder 6 and particles 8. This provides increased flexibility as to the zones, lines or contours along which bounded regions 4 can be placed.

In various applications, bounded regions 4 are provided on opposite faces of substrate 2.

In some applications, bounded regions 4 are formed by penetration of cured binder 6 into opposing faces of substrate 2. For example, drops of binder can be applied to opposite faces of substrate 2 to form an integral bounded region 4 coextensive with the thickness of substrate 2.

In some implementations, cured binder 6 is coated onto fibers of substrate 2. In other implementations, cured binder 6 encapsulates fibers of substrate 2. In other implementations, cured binder 6 fills interstices between fibers of substrate 2.

In some implementations, a top surface of cured binder 6 is substantially coplanar with a top surface of substrate 2, such that cured binder 6 does not appear to extend from substrate 2. In other implementations, bounded regions 4 are layered or built up on substrate 2. In some cases the binder forms a solid surface in the bounded regions. Preferably the binder does not undesirably increase the local stiffness of the liner in the bounded regions.

In some applications, bounded regions 4 are arranged in mold cavity 3 to retain the fabric in position against gravity and the turbulent forces generated during the foaming process.

A number of embodiments of the invention have been described. Nevertheless, it will be understood that various modifications may be made without departing from the spirit and scope of the invention. For example, bounded regions 4 can be melted into substrate 2 to produce an integral flexible fabric liner 1. Accordingly, other embodiments are within the scope of the following claims.

What is claimed is:

1. A method of molding a foam article, the method comprising providing a flexible fabric mold liner comprising a flexible fabric substrate with discrete, bounded regions carrying cured binder encapsulating fibers of the fabric substrate and containing magnetically attractable particles;
inserting the mold liner into a mold cavity, such that the liner drapes over an internal surface defining a portion of the mold cavity, with the liner positioned such that the bounded regions carrying the cured binder align with magnetic liner retention points on an internal surface of the mold cavity, whereby the liner is retained in position within the mold cavity;
introducing foamable resin into the mold cavity; and
causing the foamable resin to expand to fill the mold cavity and cover an exposed surface of the liner, such that the liner becomes bonded to, and becomes a part of, a foam body formed by the resin.

2. The method of claim 1, further comprising embedding the liner within a foam product formed in the mold cavity.

3. The method of claim 1, further comprising magnetically detecting the location of the magnetically attractable particles to align the bounded regions with the magnets in the mold cavity.

4. The method of claim 1, further comprising detecting the location of the magnetically attractable particles via detection of a luminescent or phosphorescent material added to the binder.

5. The method of claim 1, whereby the fabric liner provides a surface that has greater structural rigidity than that of the cured foam.

6. A method of making a fabric mold liner, the method comprising:
providing a flexible fabric liner substrate;
depositing in discrete, bounded regions on the substrate a binder containing magnetically attractable particles, the bounded regions arranged to correspond to magnetic liner retention points in a corresponding mold cavity; and
curing the deposited binder on the substrate to bind the magnetically attractable particles to the substrate.

7. The method of claim 6, wherein the binder encapsulates individual fibers of the fabric liner substrate.

8. The method of claim 6, further comprising cutting the fabric liner substrate to form a liner insert having a periphery shaped to correspond to a desired surface covering of a finished molded product.

9. The method of claim 6, wherein the fabric liner substrate is porous and the binder penetrates the fabric liner substrate to at least about 20 percent of the thickness of the fabric liner substrate.

10. The method of claim 6, wherein the depositing includes drawing the binder into the substrate via one of a vacuum and a magnet discrete, bounded regions.

11. The method of claim 6, further comprising detecting using magnetic sensing one of the discrete, bounded regions of the deposited binder to reference a predetermined cut to be made in the substrate.

12. The method of claim 6, further comprising coordinating the discrete, bounded regions for the depositing and a location for cutting the substrate by detection of a through-hole formed in the substrate.

13. The method of claim 6, wherein the substrate is a nonwoven fabric.

14. The method of claim 13, wherein the substrate is a spunbonded needle punched polypropylene (SNP).

15. The method of claim 6, wherein the binder comprises at least one of a water-based latex emulsion, water-based urethane binder coating, acrylic-based emulsion, oil-based emulsion, a latex paint, acrylic paint, oil-based paint, low-tack adhesive, hot melt adhesive, molten plastic resin, epoxy adhesive and vinyl resin.

16. The method of claim 6, wherein the depositing includes depositing the binder on two opposing faces of the substrate.

17. A fabric mold liner comprising:
a flexible fabric substrate; and
bounded regions of cured binder encapsulating fibers of the fabric substrate and carrying magnetically attractable particles, the bounded regions arranged to correspond to magnetic liner retention points in a corresponding mold cavity.

18. The liner of claim 17, wherein the stiffness of the bounded regions is not substantially greater than the stiffness of the bare fabric substrate.

19. The liner of claim 17, wherein the cured binder includes between about 50 and 90 percent concentration by mass of the magnetically attractable particles.

20. The liner of claim 17, wherein the liner has a periphery shaped to correspond to a desired surface covering of a finished molded product.

21. The liner of claim 17, wherein the fabric liner substrate is porous and the cured binder is present in the fabric liner substrate to a depth of at least about 20 percent of the thickness of the fabric liner substrate.

22. The liner of claim 17, wherein the fabric liner substrate is a nonwoven fabric.

23. The liner of claim 17, wherein the fabric liner substrate is a spunbonded needle punched polypropylene (SNP).

24. The liner of claim 17, wherein the fabric liner substrate is polyester felt material.

25. The liner of claim 17, wherein the cured binder comprises at least one of a water-based latex emulsion, water-based urethane binder coating, acrylic-based emulsion, oil-based emulsion, a latex paint, acrylic paint, oil-based paint, low-tack adhesive, hot melt adhesive, molten plastic resin, epoxy adhesive and vinyl resin.
